(19) United States
(12) Patent Application Publication
(10) Pub. No.: US 2023/0350426 A1
(43) Pub. Date: Nov. 2, 2023

(54) SYSTEM AND METHOD FOR DEPLOYMENT PLANNING AND COORDINATION OF A VEHICLE FLEET

(71) Applicant: CLAAS Selbstfahrende Erntemaschinen GmbH, Harsewinkel (DE)

(72) Inventors: Reinhold Mähler, Rheda-Wiedenbrück (DE); Christian Ehlert, Bielefeld (DE); Bastian Bormann, Gütersloh (DE); Joachim Baumgarten, Beelen (DE); Dennis Neitemeier, Lippetal (DE); Johann Witte, Fröndenberg (DE); Jannik Redenius, Oldendorf (DE); Arne Bohl, Gütersloh (DE); Eberhard Nacke, Gütersloh (DE); Christoph Apke, Bielefeld (DE); Timo Korthals, Leopoldshöhe (DE); Waldemar Thiesmann, Osnabrück (DE); Axel Schröder, Gütersloh (DE); Robin Monkenbusch, Rheda-Wiedenbrück (DE)

(73) Assignee: CLAAS Selbstfahrende Erntemaschinen GmbH, Harsewinkel (DE)

(21) Appl. No.: 18/139,538

(22) Filed: Apr. 26, 2023

(30) Foreign Application Priority Data
Apr. 27, 2022 (DE) 10 2022 110 106.1

(51) Int. Cl. G05D 1/02; A01B 79/00

(52) U.S. Cl. CPC G05D 1/0297; A01B 79/005; G05D 2201/0201

(57) ABSTRACT

A method and a system for deployment planning and coordinating a vehicle fleet comprising a plurality of agricultural work vehicles is disclosed. Different agricultural work processes may be performed on a field with the work vehicles having a work unit for performing at least one of the agricultural work processes. At least one work vehicle of the vehicle fleet is operated autonomously. Further, the database-driven management system may generate the deployment plan. For example, while planning a particular agricultural work process comprising a sequence of work steps, the work vehicles in the vehicle fleet are coordinated with one another by assigning at least one autonomous work vehicle to a respective work step of the agricultural work process with operational parameters being transmitted to the autonomous work vehicle in order to perform the assigned respective work step.

### CROSS REFERENCE TO RELATED APPLICATION

This application claims priority under 35 U.S.C. § 119 to German Patent Application No. DE 10 2022 110 106.1 filed Apr. 27, 2022, the entire disclosure of which is hereby incorporated by reference herein. This application incorporates by reference herein the following US applications in their entirety: U.S. application Ser. No. ______ entitled “AUTONOMOUS AGRICULTURAL PRODUCTION MACHINE” (attorney docket no. 15191-23004A (P05575/8)); ; and U.S. application Ser. No. ______ entitled “SWARM ASSISTANCE SYSTEM AND METHOD FOR AUTONOMOUS AGRICULTURAL UNIVERSAL PRODUCTION MACHINES” (attorney docket no. 15191-23005A (P05576/8)); U.S. application Ser. No. ______ entitled “METHOD AND SYSTEM FOR MONITORING AUTONOMOUS AGRICULTURAL PRODUCTION MACHINES” (attorney docket no. 15191-23006A (P05578/8)); and U.S. application Ser. No. ______ entitled “METHOD AND SYSTEM FOR MONITORING OPERATION OF AN AUTONOMOUS AGRICULTURAL PRODUCTION MACHINE” (attorney docket no. 15191-23007A (P05580/8)).

### TECHNICAL FIELD

The present invention relates to a method for deployment planning and coordination of a vehicle fleet and to a database-driven management system.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 2 177 965 B1 discloses a method for coordinating a vehicle fleet consisting of a plurality of agricultural work vehicles by which different agricultural work processes are performed on a field substantially at the same time. The work vehicles of the vehicle fleet have, for performing at least one of the agricultural work processes, work units which are a component of the work vehicle and/or are adapted to the work vehicles, wherein at least one work vehicle of the vehicle fleet is operated autonomously. According to EP 2 177 965 B1, a lead function is assigned to one vehicle of the vehicle fleet, and a follower function is assigned to the other vehicles. The vehicles to which the follower function is assigned follow the vehicle with the assigned lead function at a set lateral distance. Each vehicle has a library with machine behaviors saved therein for executing agricultural workflows, as well as a coordination system that assigns a function for executing the agricultural workflow to the particular vehicle depending on the placement of the particular vehicle, i.e. as a vehicle with a lead function or with a follower function.

### BRIEF DESCRIPTION OF THE DRAWINGS

The present application is further described in the detailed description which follows, in reference to the noted drawing by way of non-limiting examples of exemplary implementation, in which like reference numerals represent similar parts throughout the several views of the drawings, and wherein:

FIG. 1 illustrates an exemplary schematic representation of a database-driven management system for deployment planning and coordination of a vehicle fleet.

### DETAILED DESCRIPTION

As discussed in the background, EP 2 177 965 B1, each vehicle has a library with machine behaviors saved therein for executing agricultural workflows, as well as a coordination system that assigns a function for executing the agricultural workflow to the particular vehicle depending on the placement of the particular vehicle. As such, the vehicles communicate with each other taking into account the machine behaviors saved in the library, which define the execution of specific tasks or subtasks by a vehicle. The coordination of the vehicle fleet may thus be limited to the simultaneous joint operation on a field to be worked.

Thus, in one or some embodiments, an object of the invention is to further develop a method and system that enables a broader range of application for a vehicle fleet to be coordinated.

In one or some embodiments, a method for the deployment planning and coordination of a fleet of vehicles comprising (or consisting of) a plurality of agricultural work vehicles is disclosed. Using the work vehicles of the vehicle fleet, different agricultural work processes may be performed on a field basically at the same time (e.g., at least partly simultaneously) or offset in time, wherein the work vehicles may have at least one work unit for performing at least one of the agricultural work processes, which may be a component of the work vehicle and/or may be adapted to the work vehicles, and wherein at least one work vehicle of the vehicle fleet is operated autonomously (at least some (or all) of the operations are performed automatically). In one or some embodiments, by using a database-driven management system, the deployment planning may be performed out in the field, wherein while planning a particular agricultural work process comprising a sequence of work steps, the autonomous work vehicles available to the vehicle fleet to be coordinated may be integrated by assigning at least one autonomous work vehicle to each work step of the agricultural work process, wherein, in order to perform the work step assigned to the autonomous work vehicle, certain operational parameters may be transmitted by the management system, through which the at least one autonomous work vehicle may be instructed to perform the assigned work step.

The disclosed method and system are based on the consideration that a vehicle fleet to be coordinated, which may comprise at least one autonomous work vehicle (such as a plurality of several autonomous work vehicles or individual available autonomous work vehicles of this vehicle fleet), may be taken into account or considered in the planning of a work process. In the context of deployment planning, the individual autonomous work vehicles may be deployed or assigned according to the plan. In this context, the at least one autonomous agricultural work vehicle may cooperate with a manned agricultural work vehicle belonging to the vehicle fleet. In contrast to the prior art, the at least one autonomous work vehicle may be instructed by the management system through the transmission of deployment parameters regarding the assigned work step to be performed. The autonomous work vehicle may not be directly dependent on a manned work vehicle of the vehicle fleet which assumes the lead function. Rather, in one or some embodiments, the at least autonomous work vehicle may perform individual work steps of an agricultural work process which may deviate from those of other (such as manned) agricultural work vehicles, which may be performed basically at the same time (e.g., at least partly simultaneously).

The formulation of “work units”, which may be part of the work vehicle and/or which are adapted to the work vehicles, may include both work units of work vehicles designed as self-propelled harvesting machines (such as combine harvesters, forage harvesters, diggers and the like), which may be for both working and processing, as well as attachments adapted to the work vehicles designed as towing vehicles (for example, soil cultivation devices, sprayers, fertilizing devices, balers, transport wagons, attachments or the like), which may be dependent on the work vehicle designed as a towing vehicle for driving and moving.

Such autonomous work vehicles may be distinguished by the fact that an operator does not have to be present to control them and are therefore also referred to as unmanned vehicles. In this regard, any discussion regarding an autonomous work vehicle may comprise any one, any combination, or all of the functions performed by the autonomous work vehicle being fully automatic without input from an operator. In this regard, these autonomous work vehicles may partially or completely automatically execute planned agricultural work processes or work steps that they include, whereby guidance of these units during execution may take place without active intervention of a person and/or a manned work vehicle as an accompanying vehicle. For example, an autonomous work vehicle may automatically orient itself along a lane of a manned agricultural work vehicle or automatically determine its lane independently using GPS data.

In one or some embodiments, data, inter alia, may be transmitted as deployment parameters which, depending on the work step to be performed, may specify the functional scope possessed or configured to be performed by the at least one work unit of the autonomous work vehicle, or the functional scope of the at least one work unit with which the autonomous work vehicle is to be equipped. In this way, autonomous work vehicles available in the context of deployment planning may be assigned to individual work steps up to individual work processes according to their capabilities. The deployment parameters may be determined by the type of work process to be performed and the work steps contained therein. The deployment parameters may also contain data that enable the autonomous work vehicle to locate a work unit to be adapted to be picked up, for example on the farm or in the field, and/or to specify the connection means required for the adaptation (e.g., the connector for connection of the work unit to the autonomous work vehicle).

For this purpose, in one or some embodiments, information available from the management system may be determined, processed and analyzed, on the basis of which the technical requirements for the autonomous work vehicle are matched with the requirements for performing the work steps of work processes in a field.

An agricultural workflow may, for example, include harvesting the crop in a field, wherein the workflow may be divided at least into the steps of harvesting, transferring and removal. The same may apply to other work processes such as sowing, soil cultivation, fertilizing or spraying, to name just a few other agricultural work processes.

In particular, the management system may be supplied with planning data, which may be provided by one or both of: autonomous work vehicle(s) (e.g., the planning data being generated, recorded and/or determined by the autonomous, agricultural work vehicles); or external data sources. For example, the planning data supplied by the agricultural work vehicles and/or the external data sources may correlate with one another in time or be independent of one another in time. In this case, the circumstance may be exploited that the agricultural work vehicles may be equipped with at least one sensor apparatus (such as a plurality of different sensor apparatuses), in order to record, evaluate and store measurement data while performing individual work steps of a work process. In one or some embodiments, the recorded measurement data may be evaluated by a control unit of the autonomous work vehicle (e.g., a respective autonomous work vehicle may include the at least one sensor apparatus configured to generate sensor data; the respective autonomous work vehicle, using its control unit, is configured to evaluate the sensor data). Thus, in one or some embodiments, the control unit resident in the respective autonomous work vehicle may be used to optimize controlling of the respective autonomous work vehicle). These measurement data and their evaluation may be transmitted almost simultaneously, virtually in real time, or at a delay to the management system as planning data for subsequent work processes or work steps to be planned. In one or some embodiments, external data sources are data sources independent of the agricultural work vehicles, for example the Internet, satellite images and the like.

For this purpose, planning data, which may comprise any one, any combination, or all of: crop data; ground data; area data; weather data; localization data; route data; obstacle mapping data; consumption data; and machine condition data, may be supplied to the management system. In one or some embodiments, consumption data may comprise some or all data that directly relate to the use of at least the autonomous work vehicle and concern the consumption of operating and auxiliary materials. In one or some embodiments, machine condition data may comprise some or all data of at least the autonomous work vehicles and working units that relate to their operational capability.

In one or some embodiments, the planning of the particular agricultural workflow may be performed based on at least one predefined objective and/or optimization strategy. The at least one objective to be specified may be of economic and/or ecological nature. In particular, the at least one objective to be specified may relate to the entire workflow which may be limited to, for example, a soil cultivation process, a sowing process or a harvesting process on a field, or a complete growing season with all associated work processes on a field. Optimization strategies may, for example, be defined specifically for individual vehicles, such as the autonomous work vehicles (e.g., for a particular autonomous work vehicle). In particular, optimization strategies may be multi-level. For example, an optimization strategy may include at least the “on the farm”, “at the field”, and “in the field” stages. The first stage “on the farm” may concern the optimization of at least the autonomous agricultural work vehicle there with respect to its basic configuration as a preparation for the additional stages. The second stage “in the field” may relate to the optimization of at least the autonomous agricultural work vehicle there with regard to a work unit-specific configuration, and the third stage “in the field” may relate to the optimized adaptation of the basic configuration and the working unit-specific configuration while working the field.

In one or some embodiments, travel routes between a farmyard and a field to be worked as well as between fields to be worked may be determined at least partly while creating the deployment plan, and at least one type of transport may be determined depending on the number of autonomous work vehicles and their individual equipment with work units, by means of which the at least one autonomous work vehicle may be transferred according to the determined travel route. A possible type of transport may be one with a suitable means of transport, for example on a transporter, or a guided transport, for example under the supervision of an operator on the autonomous work vehicle or an accompanying vehicle, such as a manned work vehicle of the vehicle fleet. In this case, additional aspects associated with the use of autonomous work vehicles may be considered in addition to pure transport logistics. Additional aspects may be the sequence of working fields, the determination of entry and exit points of a field, such as for the purpose of loading and unloading, and the establishment of lanes to be used on the field to be processed.

In one or some embodiments, operating parameters for the at least one integrated or adapted work unit of the autonomous work vehicle may be determined and transmitted by the management system depending on the work step or work process to be performed by the at least one autonomous work vehicle. The operating parameters may be determined specifically for the particular work unit and transmitted to the autonomous work vehicle. The particular work unit may be controlled using a control device of the autonomous work vehicle or by a separate control device on the work unit according to the transmitted operating parameters.

In one or some embodiments, at least one location in the vicinity of the area to be worked by the at least one autonomous work vehicle may be determined at least partly during the creation of the deployment plan on the basis of the supplied planning data, which location is approached by the at least one autonomous work vehicle when an external event occurs which leads to the interruption of the agricultural work process. An external event may be a change in the weather or the occurrence of damage to the autonomous work vehicle or the work unit adapted thereto. In such a situation, the autonomous work vehicle may automatically move to the location so as not to obstruct other active, such as autonomous, work vehicles on the area to be worked.

In addition, it may be preferable to use the supplied planning data to determine processes for the procurement, pickup and/or transfer of resources by the autonomous work vehicles and/or between the work vehicles when creating the deployment plan. In particular, the autonomous work vehicles may require specific processes with regard to the pickup and/or transfer of resources in order to ensure their trouble-free or uninterrupted use.

In particular, the work vehicles of the vehicle fleet that are active on the field to be worked may exchange data with each other so that the at least one autonomous work vehicle is informed about the occurrence of a situation that influences the work step of the agricultural workflow to be performed. For example, the at least one autonomous work vehicle may be informed about an obstacle that has currently arisen and that could not be taken into account in a previous route planning as part of the deployment plan.

In one or some embodiments, the at least one autonomous work vehicle may acquire and/or determine operational data by at least one sensor apparatus while performing the agricultural workflow, as well as record this operational data, and the recorded operational data may be transmitted to the management system during and/or after performing the agricultural workflow. In order for the management system to determine and/or monitor the energy consumption of the at least one autonomous work vehicle, it may be useful for the at least one autonomous work vehicle to determine (such as regularly determine) and transmit operating data relating to energy consumption. This operational data relating to energy consumption may be used as a basis for deployment planning in order to plan the processes for the procurement, pickup and/or transfer of operational resources. In addition, these operating data may be used to adjust the current deployment plan for the particular autonomous work vehicle if it becomes apparent that the planned processes for procuring, picking up and/or transferring resources at least negatively influence the execution of the step to be performed in the agricultural workflow. Furthermore, operational data to be transmitted may concern the degree of processing of the work step to be performed by the autonomous work vehicle. It is also contemplated to transmit operating data relating to a state of wear of the autonomous work vehicle and/or the equipment. The operating data may be used to determine the current situation of the vehicle fleet and/or to improve future deployment planning for the particular field to be worked. In particular, the vehicle fleet may include at least one manned work vehicle, which may be taken into account when planning deployment in the field in cooperation with the at least one autonomous work vehicle.

In particular, a communication system and a localization infrastructure may be used for decentralized guidance of multiple autonomous work vehicles operating together in a field. The localization infrastructure may be provided at least partially in the field. In order to ensure safe guidance of autonomous work vehicles operating together in a field, it may be advantageous to use a locally limited localization infrastructure, whereby the spatial position of field boundaries as well as areas directly adjacent thereto is available with high accuracy. In a simple case, at least one drone may be provided as a localization structure which may visually capture in high resolution the position of any one, any combination, or all of: field boundaries; access roads; and areas directly adjacent to the field. This image data may be transmitted to the autonomous work vehicles through the common communication system to derive and store appropriate travel routes. Furthermore, the use of drones may make it possible to monitor the work quality of the at least one autonomous work vehicle. Alternatively or additionally, in addition to positioning signals, additional correction signals of a real-time kinematic system (RTK system) may be used, which may increase the accuracy of the signals provided by a satellite-based positioning system.

in high resolution the work vehicles in the vehicle fleet are managed by the management system as a pool of vehicles, wherein the use of one or more available autonomous and manned work vehicles is released in response to a user request.

Moreover, the object posed above may be achieved by a database-driven management system with a memory unit, a computing unit and a communication unit, which may be configured to perform the method disclosed herein. Reference is made to all the statements on the disclosed method for deployment planning and coordination of a vehicle fleet.

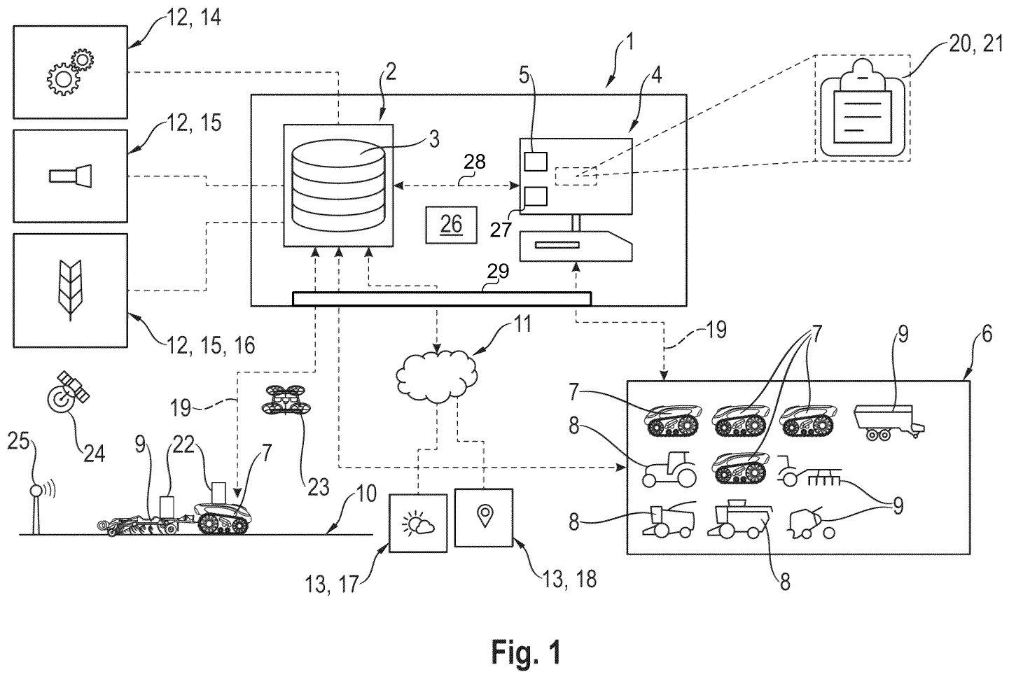

Referring to the figures, FIG. 1 shows an exemplary schematic representation of a database-driven management system 1 for deployment planning and coordination of a vehicle fleet 6. The management system 1 may comprise a memory unit 2 with at least one database 3 (and/or other type of memory) included therein and a computing unit 4, which may be configured to process data saved in the memory unit 2 (e.g., computer readable instructions, when executed by a processor of the compute unit 4, may be configured to process data). The computing unit 4 may comprise an input/output unit 5 through which data may be retrieved from the database 3, input or changed. In one or some embodiments, the memory unit 2 and the computing unit 4 may be arranged at a distance from each other. Alternatively, the memory unit 2 and the computing unit 4 may be integrated within the same electronic machine (such as the same computing device). In one or some embodiments, the storage unit 2 and the computing unit 4 may communicate with each other using a network 28. In one or some embodiments, the management system 1 may also be cloud-based.

Thus, computing unit 4 is one example of computational functionality, which may comprise at least one processor 27 and at least one memory (which may be memory unit 2 or another memory) that stores information and/or software, with the processor 27 configured to execute the software stored in the memory. In one or some embodiments, the at least one processor 15 may comprise a microprocessor, controller, PLA, or the like. The memory may comprise any type of storage device (e.g., any type of memory). Though the processor 27 and the memory (such as memory unit 2) are depicted as separate elements, they may be part of a single machine, which includes a microprocessor (or other type of controller) and a memory. Alternatively, the processor 27 may rely on memory unit 2 for all of its memory needs.

The processor 27 and memory are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Further, the computational functionality, which may include processor 27 and memory (such as memory unit 2), may be resident in one or more other electronic devices depicted in FIG. 1, including any one, any combination, or all of: autonomous work vehicle 7 (e.g., computational functionality may be configured to automatically control autonomous work vehicle 7); manned work vehicle 8; work unit 9; or drone 23.

In one or some embodiments, management system 1 may communicate with various external electronic device(s) via one or more communication interfaces 29. For example, management system 1 may communicate using communication unit 26 with any one, any combination, or all of external data source 11, autonomous work vehicle 7, work vehicle 8, work unit 9, drone 23 via one or more communication interfaces 29. In one or some embodiments, the communication unit may comprise functionality to communicate wired and/or wirelessly with external electronic devices.

The vehicle fleet 6 may comprise (or consists of) a plurality of agricultural work vehicles 7, 8, by means of which different agricultural work processes may be performed on a field substantially at the same time (e.g., at least partly or entirely overlapping in time) or with a delay. At least one of the agricultural work vehicles 7 of the vehicle fleet 6 may be operated autonomously, and at least one of the work vehicles 8 of the vehicle fleet 6 may be designed as a manned work vehicle. The term “autonomously operated work vehicle 7” may be understood as meaning that that the work vehicle 7 is capable of performing an agricultural work process comprising a sequence of work steps autonomously, automatically, and unattended without requiring any intervention by an operator. The autonomous and manned work vehicles 7, 8 may have work units 9 for performing at least one of the agricultural work processes and which may be part of the autonomous or manned work vehicle 7, 8 (e.g., are integrated into the work vehicle 7, 8, and/or are adapted to the work vehicles 7, 8, such as being mechanically connected to the work vehicles 7, 8).

In one or some embodiments, the work vehicles 7, 8 may be designed as self-propelled harvesters or towing vehicles. Work units 9 may be, in addition to the work units integrated into the particular work vehicle 7, 8, those which are adapted to the particular work vehicle 7, 8. The work units 9 to be adapted may include, for example, any one, any combination, or all of soil cultivation equipment, sprayers, fertilizer devices, balers, transport wagons, attachments or the like, which may be dependent on the work vehicle 7, 8 for driving and moving.

In one or some embodiments, an agricultural workflow may be small-scale, such as limited, for example, to harvesting a field 10 and the activities directly associated therewith may comprise (or consisting of) a sequence of several work steps to be performed (e.g., limited in time and/or space, such as limited to one day and/or one field). An agricultural workflow may also be very extensive and complex if it comprises a complete growing season from cultivation to harvesting in at least one field 10 with the associated activities.

In one or some embodiments, deployment planning and coordination in the field may be performed using the database-driven management system 1. For this purpose, the management system 1 may be supplied with planning data 12, which may be generated, recorded and/or determined by the agricultural work vehicles 7, 8 as data sources, and/or the planning data 13 may be provided by external data sources 11, which may be independent of the agricultural work vehicles 7, 8. The planning data 12, 13, supplied by the agricultural work vehicles 7, 8 and/or the external data sources 11, may be temporally correlated with each other or temporally independent of each other.

In one or some embodiments, the management system 1 may be supplied with planning data 12, 13 from the group of crop data 16, ground data, yield data 15, area data, weather data 17, localization data 18, route data, obstacle mapping data, consumption data, and machine condition data 14. Consumption data may comprise some or all data directly related to the use of at least the autonomous work vehicle 7 concerning the consumption of operating and auxiliary materials. Machine condition data 14 may comprise some or all data of at least the autonomous work vehicles 7 and work units 9, which may relate to their operational capability, for example wear data, repair data, availability and the like. Machine condition data 14 of the manned work vehicles 8 may also be supplied to the management system 1. For example, a failure of a manned work vehicle 8 may be taken into account when adjusting the deployment plan. In particular, the management system 1 may cause another autonomous work vehicle 7 to take its place if it is correspondingly suitable.

In one or some embodiments, the management system 1 may integrate at least the autonomous work vehicles 7 available to the vehicle fleet 6 to be coordinated when planning a particular agricultural work process comprising a sequence of work steps, in that at least one of the autonomous work vehicles 7 is assigned to each work step of the agricultural work process (in order to automatically perform each work step of the agricultural work process). To perform the work step assigned to the autonomous work vehicle 7, certain operational parameters 19 may be transmitted by the management system 1 to the at least one autonomous work vehicle 7, by and through which the at least one autonomous work vehicle 7 is instructed to automatically execute the assigned work step.

Among other things, data may be transmitted to the autonomous work vehicle 7 as operational parameters 19, which may specify, depending on the work step to be performed, the functional scope of at least one work unit 9 integrated in the autonomous work vehicle 7, or the functional scope of the at least one work unit 9 with which the autonomous work vehicle 7 is to be equipped.

In one or some embodiments, the deployment parameters 19 may also be used by the management system 1 to determine the suitability of the available autonomous work vehicles 7 during deployment planning.

In one or some embodiments, the particular agricultural workflow may be planned through the management system 1 based on at least one predefined objective 20 and/or optimization strategy 21. An objective 20 may, for example, be a defined time window within which a work process, such as harvesting a field, is to be completely finished. For this purpose, an operator may enter an objective 20 via the input-output unit 5 (which may comprise a touchscreen) and/or select from objectives 20 saved in the database 3. The latter may be modified by the operator. The objectives 20 may relate to the entire work process which may, for example, in one or some embodiments, be limited to a soil cultivation operation, a sowing operation or a harvesting operation in a field, or may comprise a complete growing season in the field 10.

The input/output unit 5 may also be used to input optimization strategies 21 or to select them from optimization strategies 21 already saved. Optimization strategies 21 may, for example, be defined specifically for individual work vehicles 7, such as specific autonomous work vehicles 7, and/or also for the manned work vehicles 8. In particular, the optimization strategies 21 may be multi-level. For example, an optimization strategy 21 may include at least the stages “on the farm”, “at the field” and “in the field”. The first stage “on the farm” may concern the optimization of the agricultural work vehicle 7, 8 with respect to its basic configuration as preparation for the further stages. The second stage “on the field” may concern the optimization of the agricultural work vehicle 7, 8 with regard to its work unit-specific configuration, and the third stage “in the field” may concern the optimized adaptation of the basic configuration and the work unit-specific configuration while working the field 10.

While creating the deployment plan, travel routes between a farm and a field 10 to be worked as well as between fields 10 to be worked may be determined. Depending on the number of autonomous work vehicles 7 and their individual equipment with work units 9, at least one type of transport may be determined by means of which the at least one autonomous work vehicle 7 is transferred according to the determined route. The transfer of the at least one autonomous work vehicle 7 on a public road may, for example, take place using a transporter. Between contiguous fields 10, the at least one autonomous work vehicle 7 may automatically move independently according to a predetermined travel route or be guided by an accompanying vehicle, in particular one of the manned work vehicles 8.

While creating the deployment plan on the basis of the supplied planning data, at least one location in the vicinity of the field 10 to be worked by the at least one autonomous work vehicle 7 may be determined, which location is approached by the at least one autonomous work vehicle 7, such as autonomously, when an external event occurs which may lead to the interruption of the agricultural work process. This may serve to take into account external events such as a change in the weather or the occurrence of damage to the autonomous work vehicle 7 that may prevent further execution of the work step. In such a situation, the relevant autonomous work vehicle 7 may approach the location autonomously and automatically so as not to obstruct other work vehicles 7, 8 located in the field 10.

According to another aspect, it may be preferable to use the supplied planning data to determine processes for the procurement, pickup and/or transfer of resources by the autonomous work vehicles and/or between the autonomous and manned work vehicles 7, 8 when creating the deployment plan. In so doing, the work vehicles 7, 8 of the vehicle fleet 6 that are active on the field 10 to be worked may exchange data with each other. In particular, the autonomous work vehicles 7 may automatically monitor their operating resources using sensors (see sensor apparatus 22) in order to detect an acute requirement and to transmit this to an autonomous work vehicle 7 provided for this purpose. Operating resources may be, for example, fuels, seeds, fertilizers or the like.

In particular, the work vehicles 7, 8 of the vehicle fleet 6 active on the field to be worked may exchange data with each other so that the at least one autonomous work vehicle is at least informed about the occurrence of a situation that influences or affects the work step of the agricultural workflow to be performed.

Using the at least one autonomous work vehicle 7, operating data may be detected and/or determined as well as recorded by at least one sensor apparatus 22 associated with the autonomous work vehicle 7 at least partly while the autonomous work vehicle 7 perform the agricultural work process. The at least one sensor apparatus 22 may be arranged or positioned on the autonomous work vehicle 7 and/or on the work unit 9 to be adapted. If the autonomous work vehicle 7 has integrated work units 9, at least one sensor apparatus 22 may be assigned to them. The operating data recorded by the autonomous work vehicle 7 may be automatically transmitted to the management system 1 during and/or after the execution of the agricultural work process.

For the decentralized guidance of several autonomous work vehicles 7 operating together in the field 10, a communication system as well as a localization infrastructure may be used, which may be provided in the field 10. The communication system is, for example, a radio network which may enable the work vehicles 7, 8 to communicate at least with each other during their use on the field 10. Alternatively, or in addition, the radio network may also be used to communicate with the management system 1.

In order to ensure safe guidance of autonomous work vehicles 7 operating together in a field, it may be advantageous to use a locally limited localization infrastructure, whereby the spatial position of field boundaries and/or of areas directly adjacent thereto may be available with high accuracy. In a simple case, at least one drone 23 may be provided as a localization structure, which may visually capture the position of field boundaries, access roads and areas directly adjacent to the field 10 in high resolution. This image data may be transmitted through the common communication system to the management system 1 and/or the autonomous work vehicles 7 to derive and store appropriate travel routes. Furthermore, the use of drones 23 may make it generally possible to monitor the work quality of the at least one autonomous work vehicle 7 on the field 10. Alternatively or additionally, in addition to positioning signals of a satellite 24, additional correction signals of a real-time kinematic system 25 (RTK system) may be used which may increase the accuracy of the signals provided by a satellite-based positioning system. The localization data 18 may be provided using the localization infrastructure (e.g., the radio network). Furthermore, using the localization infrastructure, the route data or obstacle mapping data may be created, or existing ones may be modified.

According to a further aspect, the autonomous and manned work vehicles 7, 8 of the vehicle fleet 6 as well as the work units 9 to be adapted thereto may be managed by the management system 1 as a vehicle pool, wherein the use of one or more available autonomous and/or manned work vehicles 7, 8 may be released in response to a user request. In this context, a user request may be transmitted to the management system 1 using a data processing device, which may be designed as a stationary computer or as a mobile data processing device, such as a cell phone or tablet. In one or some embodiments, the user request may contain order data that indicate the type, scope and time of use of one or more available autonomous and manned work vehicles 7, 8. Responsive to receiving the user request, a person administering the management system 1 may decide on the user request after an analysis of the order data by the management system 1. An automatic response to the user request by the administration system 1 is also contemplated. This aspect of the invention may be of particular importance for contractors.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Management system

2 Memory unit

3 Database

4 Computing unit

5 Input/output unit

6 Vehicle fleet

7 Autonomous work vehicle

8 Work vehicle

9 Work unit

10 Field

11 External data source

12 Planning data

13 Planning data

14 Machine condition data

15 Yield data

16 Crop data

17 Weather data

18 Localization data

19 Deployment parameters

20 Objectives

21 Optimization strategy

22 Sensor apparatus

23 Drone

24 Satellite

25 Real-time communication system

26 Communication unit

27 Processor

28 Network

29 Communication interface

1. A method for generating a deployment plan and coordinating a vehicle fleet, the method comprising:
generating, using a database-driven management system, the deployment plan for performing a plurality of agricultural work processes on a field, with the plurality of agricultural work processes including a plurality of work steps, the deployment plan comprising using the vehicle fleet that includes a plurality of agricultural work vehicles, wherein the agricultural work vehicles have at least one work unit, being one or both of a component of a respective agricultural work vehicle or adapted to the respective agricultural work vehicle, for performing at least one of the plurality of agricultural work processes, wherein the vehicle fleet includes at least one autonomous agricultural work vehicle; and
coordinating, using the deployment plan, amongst the plurality of agricultural work vehicles to assign the plurality of work steps including assigning the at least one autonomous agricultural work vehicle at least one work step from the plurality of work steps, wherein coordinating comprises transmitting, by the management system, one or more parameters to the plurality of agricultural work vehicles, including to the at least one autonomous agricultural work vehicle so that the at least one autonomous agricultural work vehicle performs the at least one work step automatically.

2. The method of claim 1, wherein at least one work unit is part of the at least one autonomous agricultural work vehicle or the at least one work unit is connected to the at least one autonomous agricultural work vehicle; and
wherein the one or more parameters comprise deployment parameters which, depending on the at least one work step to be performed by the at least one autonomous agricultural work vehicle, specify functional scope possessed by the at least one work unit.

3. The method of claim 1, wherein the management system receives planning data which are from one or both of a respective agricultural work vehicle of the plurality of agricultural work vehicles or from an external data source;
wherein the respective agricultural work vehicle performs at least one of generating, recording, or determining the planning data; and
wherein the planning data supplied by one or both of the respective agricultural work vehicle or the external data source correlate with one another in time or are independent of one another in time.

4. The method of claim 3, wherein the planning data, received by the management system, comprises one or more of: crop data; ground data; yield data; area data; weather data; localization data; route data; obstacle mapping data; consumption data; or machine condition data.

5. The method of claim 3, wherein while creating the deployment plan based on the planning data, at least one location in a vicinity of the field to be worked by the at least one autonomous agricultural work vehicle is determined;
further comprising:
identifying an external event;
responsive to identifying the external event:
interrupting a respective agricultural work process being performed by the at least one autonomous agricultural work vehicle; and
automatically moving the at least one autonomous agricultural work vehicle to the at least one location.

6. The method of claim 3, wherein, when generating the deployment plan using the planning data, processes for one or more of procurement, pickup or transfer of operating resources for one or both of the at least one autonomous agricultural work vehicle or between the plurality of agricultural work vehicles are determined.

7. The method of claim 1, wherein the deployment plan is performed based on one or both of a predefined objective or an optimization strategy.

8. The method of claim 1, wherein the deployment plan is for a plurality of fields to be worked including a first field to be worked and at least a second field to be worked; and
wherein travel routes between a farmyard and the first field to be worked and between first field and the second field to be worked are determined while creating the deployment plan;
wherein at least one type of transport is determined depending on number of autonomous agricultural work vehicles are used in the deployment plan and their individual equipment with work units; and
wherein the at least one autonomous agricultural work vehicle is transferred according to the travel routes.

9. The method of claim 1, wherein the at least one autonomous agricultural work vehicle has a respective work unit integrated therein or adapted thereto; and
wherein operating parameters for the at least one autonomous agricultural work vehicle or the respective work unit adapted thereto are determined and transmitted by the management system depending on a respective agricultural work process to be performed by the at least one autonomous agricultural work vehicle.

10. The method of claim 1, further comprising the plurality of agricultural work vehicles of the vehicle fleet that are active on the field to be worked exchange data with each other so that the at least one autonomous agricultural work vehicle is informed about an occurrence of a situation that influences the at least one work step to be performed by the at least one autonomous agricultural work vehicle.

11. The method of claim 1, wherein the at least one autonomous agricultural work vehicle performs one or both of acquiring or determining operational data based on sensor data generated at least one sensor apparatus resident on the at least one autonomous agricultural work vehicle while the at least one autonomous agricultural work vehicle performs the at least one work step;
wherein the at least one autonomous agricultural work vehicle records the operational data; and
wherein the at least one autonomous agricultural work vehicle transmits the operational data to the management system during or after performing at least one work step.

12. The method of claim 1, wherein the vehicle fleet comprises at least one manned work vehicle and the at least one autonomous agricultural work vehicle; and
wherein both of the at least one manned work vehicle and the at least one autonomous agricultural work vehicle are taken into account when generating the deployment plan so that the at least one manned work vehicle works in cooperation with the at least one autonomous agricultural work vehicle.

13. The method of claim 1, wherein the fleet comprises a plurality of autonomous agricultural work vehicles; and
wherein a communication system and a localization infrastructure are used for decentralized guidance and control of the plurality of autonomous agricultural work vehicles operating together in the field.

14. The method of claim 1, wherein the fleet comprises a plurality of autonomous agricultural work vehicles;
wherein the autonomous agricultural work vehicles in the vehicle fleet are managed by the management system as a pool of vehicles;
wherein a user request is input to the management system indicating a request to release one or more available autonomous agricultural work vehicles and manned agricultural work vehicles; and
wherein, responsive to the user request, use of the one or more available autonomous agricultural work vehicles and manned agricultural work vehicles are released.

15. A management system comprising:
a communication interface;
a memory unit; and
a computing unit in communication with the communication interface and the memory unit, the computing unit configured to:
generate a deployment plan for performing a plurality of agricultural work processes on a field, with the plurality of agricultural work processes including a plurality of work steps, the deployment plan comprising using a vehicle fleet that includes a plurality of agricultural work vehicles, wherein the agricultural work vehicles have at least one work unit, being one or both of a component of a respective agricultural work vehicle or adapted to the respective agricultural work vehicle, for performing at least one of the plurality of agricultural work processes, wherein the vehicle fleet includes at least one autonomous agricultural work vehicle; and
coordinate, using the deployment plan, amongst the plurality of agricultural work vehicles to assign the plurality of work steps including assigning the at least one autonomous agricultural work vehicle at least one work step from the plurality of work steps, wherein coordinating comprises transmitting, by the management system, one or more parameters to the plurality of agricultural work vehicles, including to the at least one autonomous agricultural work vehicle so that the at least one autonomous agricultural work vehicle performs the at least one work step automatically.

16. The management system of claim 15, wherein the management system is further configured to receive planning data which are from one or both of a respective agricultural work vehicle of the plurality of agricultural work vehicles or from an external data source;
wherein management system is configured to receive the planning data from the respective agricultural work vehicle; and
wherein the planning data supplied by one or both of the respective agricultural work vehicle or the external data source correlate with one another in time or are independent of one another in time.

17. The management system of claim 16, wherein the planning data, received by the management system, comprises one or more of: crop data; ground data; yield data; area data;
weather data; localization data; route data; obstacle mapping data; consumption data; or machine condition data.

18. The management system of claim 17, wherein, when the computing unit is generating the deployment plan using the planning data, the computing unit is further configured to determine processes for one or more of procurement, pickup or transfer of operating resources for one or both of the at least one autonomous agricultural work vehicle or between the plurality of agricultural work vehicles.

19. The management system of claim 16, wherein the deployment plan is performed based on one or both of a predefined objective or an optimization strategy.

20. The management system of claim 16, wherein the computing unit is configured to generate the deployment plan for a plurality of fields to be worked including a first field to be worked and at least a second field to be worked; and
wherein the computing unit, as part of the deployment plan, is configured to determine travel routes between a farmyard and the first field to be worked and between first field and the second field to be worked are determined while creating the deployment plan.
